(19) United States
(12) Patent Application Publication
(10) Pub. No.: US 2026/0106468 A1
(43) Pub. Date: Apr. 16, 2026

(54) ELECTRICITY STORAGE SYSTEM

(71) Applicant: YAZAKI CORPORATION, Tokyo (JP)

(72) Inventor: Tomoyuki Suzuki, Susono-shi (JP)

(21) Appl. No.: 19/418,268

(22) Filed: Dec. 12, 2025

Related U.S. Application Data
(63) Continuation of application No. PCT/JP2024/023893, filed on Jul. 2, 2024.

(30) Foreign Application Priority Data
Aug. 7, 2023 (JP) 2023-128276

(51) Int. Cl. H02J 7/50; H01M 10/42; H01M 10/46; H01M 50/509; H02J 3/32; H02J 7/00; H02J 7/82; H02J 101/22

(52) U.S. Cl. CPC H02J 7/50; H01M 10/425; H01M 10/46; H01M 50/509; H02J 3/32; H02J 7/82; H02J 7/855; H01M 2220/10; H02J 2101/22

(57) ABSTRACT

An electricity storage system includes a plurality of strings, a solar power generation device, and an array system that executes control of matching voltage, phase, and frequency of a slave string with those of a master string. The array system acquires information on a remaining discharge power capacity and a remaining charge power capacity of each of the plurality of strings, determines a string having the remaining discharge power capacity equal to or less than a first threshold and a string having the remaining charge power capacity equal to or less than a second threshold as a low-capacity string, and selects the master string based on a total value of the remaining discharge power capacity and the remaining charge power capacity of each master candidate string excluding the determined low-capacity string.

### CROSS-REFERENCE TO RELATED APPLICATIONS

This is a continuation of International Application No. PCT/JP2024/023893 filed on Jul. 2, 2024, and claims priority from Japanese Patent Application No. 2023-128276 filed on Aug. 7, 2023, the entire content of which is incorporated herein by reference.

### TECHNICAL FIELD

The present disclosure relates to an electricity storage system.

### BACKGROUND ART

In the related art, an electricity storage system including a plurality of electricity storage devices has been considered to stably supply electricity to a load, in addition to grid power such as a commercial power supply as disclosed in, for example, JP2017-184582A. In the electricity storage system, when grid power cannot be obtained due to a power failure or the like, one of the plurality of electricity storage devices becomes a master electricity storage device, and the other electricity storage devices become slave electricity storage devices that operate following the master electricity storage device. The master electricity storage device can be switched to the slave electricity storage device, and any one of the slave electricity storage devices can be switched to the master electricity storage device.

However, in the electricity storage system of JP2017-184582A, selection of the master electricity storage device is not particularly considered, the master electricity storage device may be frequently switched, and control becomes more difficult when the master electricity storage device is switched. More specifically, when the grid power cannot be obtained, the slave electricity storage devices need to be operated to follow the master electricity storage device, and the slave electricity storage devices need to match a voltage, a phase, and a frequency of the master electricity storage device. However, this matching control is not easy, and becomes more difficult when the number of times of switching of the master electricity storage device is large.

The present disclosure provides an electricity storage system that can reduce the number of times of switching of a master electricity storage device.

### SUMMARY

An electricity storage system according to the present disclosure is an electricity storage system that operates in a first operation mode when grid power is supplied to a load and in a second operation mode when the grid power is not supplied to the load, the electricity storage system including: a plurality of electricity storage devices connected in parallel to the load; a separate system device configured to supply power obtained by natural energy to the load and the plurality of electricity storage devices; and a control unit configured to control discharging from the plurality of electricity storage devices to the load and charging from the separate system device to the plurality of electricity storage devices, and to perform control to select a master electricity storage device from the plurality of electricity storage devices when an operation mode is shifted from the first operation mode to the second operation mode or when it is necessary to reselect a master electricity storage device, and match voltage, phrase, and frequency between the master electricity storage device and a slave electricity storage device except the master electricity storage device among the plurality of electricity storage devices. The control unit includes: an acquisition unit configured to acquire information on a remaining discharge power capacity indicating a discharge power capacity until reaching a discharge end voltage and a remaining charge power capacity indicating a charge power capacity until reaching a charge end voltage for each of the plurality of electricity storage devices; a determination unit configured to determine, among the plurality of electricity storage devices, an electricity storage device whose remaining discharge power capacity acquired by the acquisition unit is equal to or less than a first threshold as a low-capacity electricity storage device, and an electricity storage device whose remaining charge power capacity acquired by the acquisition unit is equal to or less than a second threshold as the low-capacity electricity storage device; and a selection unit configured to select the master electricity storage device based on a total value of the remaining discharge power capacity and the remaining charge power capacity acquired by the acquisition unit of each electricity storage device that is a master candidate excluding the low-capacity electricity storage device determined by the determination unit from the plurality of electricity storage devices.

### ADVANTAGEOUS EFFECTS OF DISCLOSURE

According to the present disclosure, it is possible to provide an electricity storage system that can reduce the number of times of switching of a master electricity storage device.

### BRIEF DESCRIPTION OF DRAWINGS

FIG. 1 is a block diagram showing an electricity storage system according to an embodiment of the present disclosure;

FIG. 2 is a block diagram of an array system shown in FIG. 1;

FIG. 3 is a graph showing an example of remaining discharge power capacities and remaining charge power capacities when there are nine strings;

FIG. 4 is a graph showing an example of the remaining discharge power capacities and the remaining charge power capacities of master candidates excluding low-capacity strings from the first to ninth strings shown in FIG. 3; and

FIG. 5 is a flowchart showing a master string selection method according to the present embodiment.

### DESCRIPTION OF EMBODIMENTS

Hereinafter, the present disclosure will be described with reference to a preferred embodiment. The present disclosure is not limited to the embodiment to be described below, and can be appropriately changed without departing from the gist of the present disclosure. In the embodiment to be described below, there may be parts in which illustration and description of a part of a configuration are omitted, and it is needless to say that a publicly known or well-known technique is appropriately applied to details of an omitted technique within a range in which no contradiction with contents to be described below occurs.

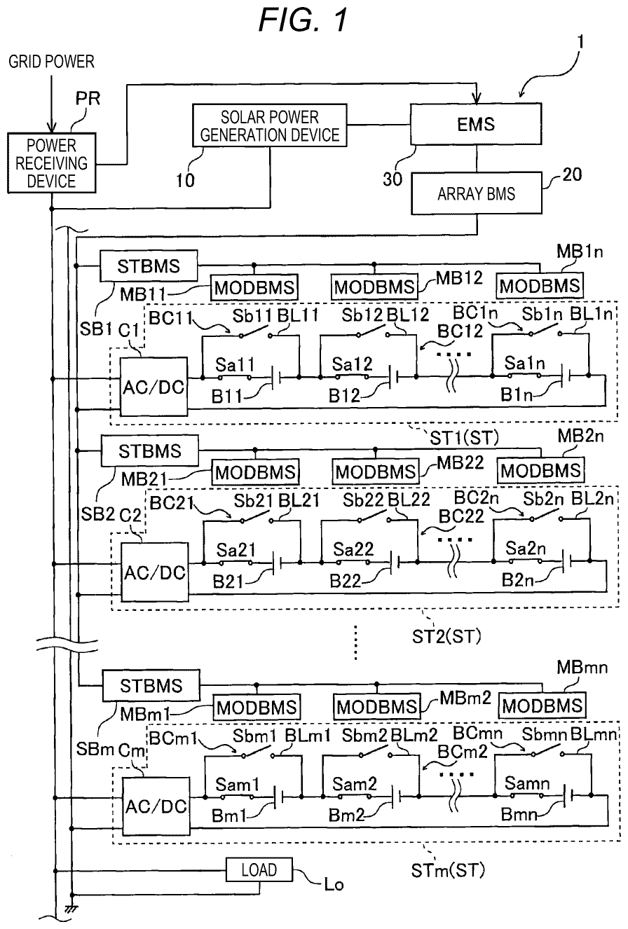

FIG. 1 is a block diagram showing an electricity storage system according to an embodiment of the present disclosure. As shown in FIG. 1, an electricity storage system 1 is provided to stabilize power supply from grid power such as a commercial power supply to a load Lo, and includes a plurality of strings (electricity storage devices) ST1 to STm, a solar power generation device (separate system device) 10, module battery management systems (hereinafter referred to as MOD systems) MB11 to MBmn, a plurality of string battery management systems (hereinafter referred to as ST systems) SB1 to SBm, an array battery management system (control unit: hereinafter referred to as an array system) 20, and an energy management system (EMS) 30.

The plurality of (m: m is a natural number of 2 or more) strings ST1 to STm are connected in parallel to the load Lo, and respectively include a plurality of storage batteries B11 to Bmn, a plurality of bypass circuits BC11 to BCmn, and AC/DC converters C1 to Cm.

The plurality of storage batteries B11 to Bmn (n: n is a natural number of 2 or more) are provided in the respective strings ST1 to STm. In the strings ST1 to STm, n storage batteries B11 to Bmn are connected in series. Each of the storage batteries B11 to Bmn is formed as, for example, a module including a plurality of unit cells, but is not particularly limited thereto, and may be formed of a single cell. In the present embodiment, it is assumed that the plurality of storage batteries B11 to Bmn are, for example, used batteries or batteries manufactured by different manufacturers, and the strings ST1 to STm have different capacities.

The bypass circuits BC11 to BCmn are circuits for bypassing a part of the storage batteries B11 to Bmn in the strings ST1 to STm to be disconnected from a series connection state. The bypass circuits BC11 to BCmn can be shifted between a bypass state in which the storage batteries B11 to Bmn are bypassed and a connection state in which the storage batteries B11 to Bmn are not bypassed, and all the bypass circuits BC11 to BCmn have the same configuration. Thus, the 11th bypass circuit BC11 will be described below as an example.

The 11th bypass circuit BC11 includes a first switch Sa11, a bypass line BL11, and a second switch Sb11. The first switch Sa11 is closer to the AC/DC converter C1 than the storage battery B11 is, and is switchable between an ON state and an OFF state by being opened and closed. The bypass line BL11 is a conductive line that bypasses the storage battery B11 from an AC/DC converter C1 side of the first switch Sa11 and is connected to a side of the storage battery B11 opposite from the AC/DC converter C1. The second switch Sb11 is provided on the bypass line BL11 and is switchable between the ON state and the OFF state by being opened and closed. As shown in FIG. 1, when the first switch Sa11 is turned on and the second switch Sb11 is turned off, the 11th bypass circuit BC11 connects the storage battery B11 to the other storage batteries B12 to B1n in series. On the other hand, when the first switch Sa11 is turned off and the second switch Sb11 is turned on, the 11th bypass circuit BC11 bypasses the storage battery B11 and enters the bypass state in which the 11th bypass circuit BC11 is not connected in series with the other storage batteries B12 to B1n. The 11th bypass circuit BC11 prevents both the first switch Sa11 and the second switch Sb11 from being instantaneously turned on at the same time by interposing a period in which both the first switch Sa11 and the second switch Sb11 are turned off when switching between the series connection state and the bypass state.

The AC/DC converters C1 to Cm are so-called power conditioning systems (PCSs), and are respectively provided at portions that are inlets of the strings ST1 to STm. The AC/DC converters C1 to Cm perform voltage adjustment (AC/DC conversion) during charging and discharging of the plurality of storage batteries B11 to Bmn constituting the strings ST1 to STm.

The solar power generation device 10 generates power by receiving sunlight. The solar power generation device 10 can supply the generated power to the load Lo. The solar power generation device 10 can further supply the generated power to each of the plurality of strings ST1 to STm to charge the storage batteries B11 to Bmn in the strings ST1 to STm. In the present embodiment, although the solar power generation device 10 is taken as an example, the present disclosure is not particularly limited thereto, and a corresponding device may generate power using wind power, wave power, and other natural energy as long as the device generates power using natural energy.

The MOD systems MB11 to MBmn perform switch control of the bypass circuits BC11 to BCmn, monitor states of the storage batteries B11 to Bmn, and the like. The MOD systems MB11 to MBmn calculate discharge power capacities until reaching discharge end voltages and charge power capacities until reaching charge end voltages for the respective storage batteries B11 to Bmn. Various publicly known or well-known methods are adopted for the discharge and charge power capacity calculation by the MOD systems MB11 to MBmn. For example, the MOD systems MB11 to MBmn measure capacities of the storage batteries B11 to Bmn in advance, and then sequentially calculate states of charge (SOCs) and deterioration degrees of the storage batteries B11 to Bmn to calculate the discharge and charge power capacities.

The ST systems SB1 to SBm grasp states of the strings ST1 to STm, control the AC/DC converters C1 to Cm, and the like. The ST systems SB1 to SBm grasp the states (at least the remaining charge power capacities and the remaining discharge power capacities) of the strings ST1 to STm by collecting information from the plurality of MOD systems MB11 to MBmn in the strings ST1 to STm. Further, the ST systems SB1 to SBm grasp information on the remaining charge power capacities and the remaining discharge power capacities for a plurality of patterns when the bypass circuits BC11 to BCmn in the strings ST1 to STm are in the series connection state and the bypass state. This will be described in detail later in an overview of operation.

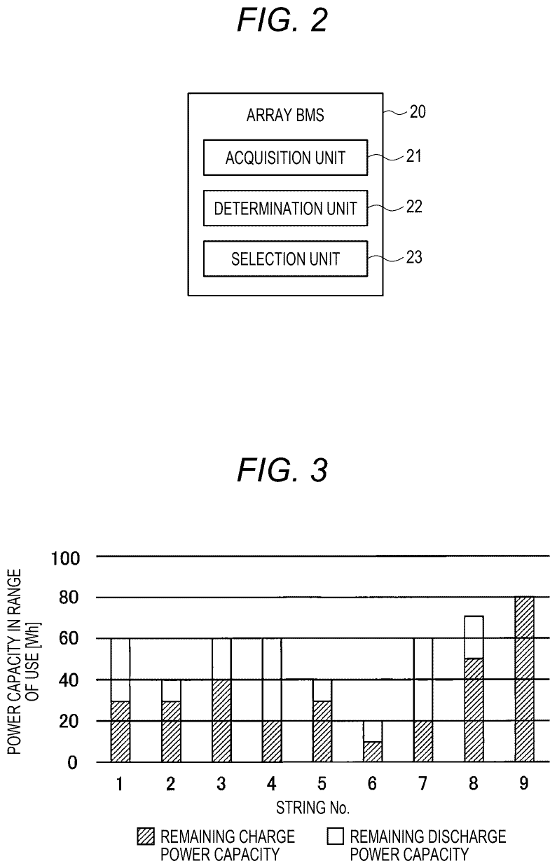

FIG. 2 is a block diagram of the array system 20 shown in FIG. 1. As shown in FIG. 2, the array system 20 executes overall control of the electricity storage system 1, and controls discharging from the plurality of strings ST1 to STm to the load Lo and charging from the solar power generation device 10 to the plurality of strings ST1 to STm.

The array system 20 executes a first operation mode and a second operation mode during the discharging to the load Lo. The first operation mode is an operation mode in which the plurality of strings ST1 to STm follow the grid power (that is, voltage, phase, and frequency are matched) when the grid power is supplied to the load Lo. The second operation mode is an operation mode in which, when the grid power is not supplied to the load Lo, a master string (master electricity storage device) ST (a string (including a master string, a slave string to be described later, and a low-capacity string to be described later) when none of the plurality of strings ST1 to STm is specified is indicated by the reference sign ST) is selected from the plurality of strings ST1 to STm. The second operation mode is further an operation mode in which the strings ST other than the master string ST are slave strings (slave electricity storage devices) ST and the slave strings ST follow the master string ST (that is, voltage, phase, and frequency are matched). The array system 20 performs charge and discharge control in response to an instruction from the EMS 30 described later in the first operation mode. In addition, the array system 20 determines charging and discharging based on a voltage and a frequency of a power line (not shown) connected to a power receiving point in the second operation mode.

The array system 20 includes an acquisition unit 21, a determination unit 22, and a selection unit 23.

The acquisition unit 21 acquires information on the remaining discharge power capacity and the remaining charge power capacity of each of the plurality of strings ST1 to STm. The acquisition unit 21 acquires the information on the remaining discharge power capacity and the remaining charge power capacity of each of the plurality of strings ST1 to STm by receiving information on each of the strings ST1 to STm from a respective one of the ST systems SB1 to SBm.

The determination unit 22 determines, as a low-capacity string (low-capacity electricity storage device) ST, a string whose remaining discharge power capacity acquired by the acquisition unit 21 is equal to or less than a first threshold among the plurality of strings ST1 to STm. In addition, the determination unit 22 determines, as the low-capacity string ST, a string whose remaining charge power capacity acquired by the acquisition unit 21 is equal to or less than a second threshold among the plurality of strings ST1 to STm. That is, the determination unit 22 determines, as the low-capacity string ST, a string whose remaining discharge power capacity is equal to or less than the first threshold and has no margin for discharging and a string whose remaining charge power capacity is equal to or less than the second threshold and has no margin for charging.

The selection unit 23 selects the master string ST from master candidate strings ST excluding the low-capacity string ST determined by the determination unit 22 among the plurality of strings ST1 to STm. At this time, the selection unit 23 selects the master string ST based on a total value of the remaining discharge power capacity and the remaining charge power capacity acquired by the acquisition unit 21. In the present embodiment, the selection unit 23 determines the string ST having a largest total value as the master string ST.

Reference is made again to FIG. 1. The EMS 30 determines whether the grid power is in a state (power failure state) in which the grid power cannot be supplied to the load Lo based on a signal from a power receiving device PR that receives the grid power. The EMS 30 transmits information on whether the grid power is in the power failure state to the array system 20. The array system 20 determines whether to execute the first operation mode or the second operation mode based on this information. When a target SOC of the electricity storage system 1 (all of the plurality of strings ST1 to STm) is determined, the EMS 30 transmits this information to the array system 20. When the electricity storage system 1 is sufficiently charged, the EMS 30 further transmits a signal for restricting a power generation amount to the solar power generation device 10.

In the electricity storage system 1 as described above, when an operation mode is shifted from the first operation mode to the second operation mode, the master string ST can be selected so that the number of times of switching of the master string ST is reduced. Hereinafter, an overview of a method for selecting the master string ST of the electricity storage system 1 will be described.

FIG. 3 is a graph showing an example of the remaining discharge power capacities and the remaining charge power capacities when there are nine strings ST1 to STm. As shown in FIG. 3, the acquisition unit 21 acquires, for example, information indicating that the remaining discharge power capacity of the first string ST1 is 30 Wh and the remaining charge power capacity is 30 Wh from the first ST system SB1. The acquisition unit 21 further acquires, for example, information indicating that the remaining discharge power capacity of the second string ST2 is 10 Wh and the remaining charge power capacity is 30 Wh from the second ST system SB2. Similarly, the acquisition unit 21 acquires information on the remaining discharge power capacity and the remaining charge power capacity of each of the strings ST3 to ST9 from the third to ninth ST systems SB3 to SB9.

For example, the first threshold is 10 Wh and the second threshold is also 10 Wh. In this case, the determination unit 22 determines that the second string ST2 is the low-capacity string ST since the remaining discharge power capacity is equal to or less than the first threshold. Similarly, the determination unit 22 determines the fifth, sixth, and ninth strings ST5, ST6, and ST9 as the low-capacity strings ST.

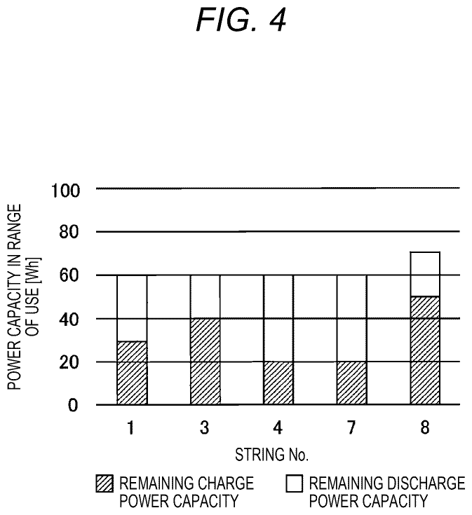

FIG. 4 is a graph showing an example of the remaining discharge power capacities and the remaining charge power capacities of master candidates excluding the low-capacity strings ST from the first to ninth strings ST1 to ST9 shown in FIG. 3. As shown in FIG. 4, the selection unit 23 extracts the first, third, fourth, seventh, and eighth strings ST1, ST3, ST4, ST7, and ST8 excluding the low-capacity strings ST among the first to ninth strings ST1 to ST9. The extracted first, third, fourth, seventh, and eighth strings ST1, ST3, ST4, ST7, and ST8 are master candidates.

Thereafter, the selection unit 23 checks the total value of the remaining discharge power capacity and the remaining charge power capacity for each of the master candidate strings ST. Here, in the example shown in FIG. 4, the total values of the first, third, fourth, seventh, and eighth strings ST1, ST3, ST4, ST7, and ST8 are 60 Wh, 60 Wh, 60 Wh, 60 Wh, and 70 Wh, respectively. For this reason, the selection unit 23 determines the eighth string ST8 having the largest total value as the master string ST.

After the master string ST is determined as described above, the array system 20 sets the eighth string ST8 as the master string ST, and sets the first to seventh and ninth strings ST1 to ST7 and ST9 as the slave strings ST. Then, the array system 20 instructs the ST systems SB1 to SB7 and SB9 of the first to seventh and ninth strings ST1 to ST7 and ST9 that are the slave strings ST to perform follow-up control. As a result, the ST systems SB1 to SB7 and SB9 execute control to match voltages, phases, and frequencies of the first to seventh and ninth strings ST1 to ST7 and ST9 with those of the eighth string ST8 that is the master string ST.

Here, for each of the plurality of strings ST1 to STm, the acquisition unit 21 preferably acquires information on the remaining discharge power capacity and the remaining charge power capacity for a plurality of patterns when one of the plurality of bypass circuits BC11 to BCmn is in the bypass state.

At this time, for each of the plurality of strings ST1 to STm, for example, the acquisition unit 21 preferably acquires the information on the remaining discharge power capacity and the remaining charge power capacity for all patterns when each of the bypass circuits BC11 to BC1n is in the bypass state. The first string ST1 will be described as an example. For example, when the number of the storage batteries B11 to B1n of the first string ST1 is four (n=4), the first ST system SB1 acquires the information on the remaining discharge power capacity and the remaining charge power capacity for 15 patterns of 2×2×2×2−1. Then, the first ST system SB1 transmits the information on the remaining discharge power capacity and the remaining charge power capacity of 15 patterns. Accordingly, the acquisition unit 21 of the array system 20 acquires the information on the remaining discharge power capacity and the remaining charge power capacity for all patterns. The above “−1” is to exclude a case where all the bypass circuits BC11 to BC14 are in the bypass state. The same applies to the second to mST systems SB2 to SBm.

Further, the acquisition unit 21 may acquire the information on the remaining discharge power capacity and the remaining charge power capacity not only for all patterns but also for a part of the patterns. The first string ST1 will be described as an example. For example, the first ST system SB1 grasps a remaining discharge current capacity for the storage batteries B11 to B1n of the first string ST1. Thereafter, the first ST system SB1 increases the number of the bypass circuits BC11 to BC1n that are in the bypass state in ascending order of the remaining discharge current capacity, and calculates and transmits the information on the remaining discharge power capacity and the remaining charge power capacity for (n−1) patterns. Accordingly, the acquisition unit 21 of the array system 20 acquires the information on the remaining discharge power capacity and the remaining charge power capacity for (n−1) patterns. The same applies to the second to mST systems SB2 to SBm. In the above description, the information on the remaining discharge power capacity and the remaining charge power capacity is calculated for (n−1) patterns with reference to the remaining discharge current capacity, but the present disclosure is not limited thereto. For example, not only the remaining discharge current capacity but also a remaining charge current capacity may be used as a reference. Further, the information on the remaining discharge power capacity and the remaining charge power capacity may be calculated for patterns ((n−1)×2 patterns) of both the remaining discharge current capacity and the remaining charge current capacity, or the information on the remaining discharge power capacity and the remaining charge power capacity may be calculated based on completely different criteria.

As described above, when the acquisition unit 21 acquires the information on the remaining discharge power capacity and the remaining charge power capacity for the plurality of patterns of the bypass circuits BC11 to BCmn, the selection unit 23 specifies the bypass state having the largest total value of the remaining discharge power capacity and the remaining charge power capacity. Then, the selection unit 23 executes the processing described with reference to FIGS. 3 and 4 in the bypass state having the largest total value of the remaining discharge power capacity and the remaining charge power capacity.

Further, when the array system 20 receives the information on the target SOC from the EMS 30, the selection unit 23 may determine the master string ST not only from the total value of the remaining discharge power capacity and the remaining charge power capacity but also from a relationship between a current SOC of the electricity storage system 1 and the target SOC. For example, when the current SOC is higher than the target SOC, there is a high probability that discharging will proceed thereafter. Therefore, the selection unit 23 may select the string ST having the largest remaining discharge power capacity as the master string ST from the strings ST each having the total value of the remaining discharge power capacity and the remaining charge power capacity equal to or greater than a third threshold. Similarly, when the current SOC is lower than the target SOC, there is a high probability that charging will proceed thereafter. Therefore, the selection unit 23 may select the string ST having the largest remaining charge power capacity as the master string ST from the strings ST each having the total value of the remaining discharge power capacity and the remaining charge power capacity equal to or greater than the third threshold.

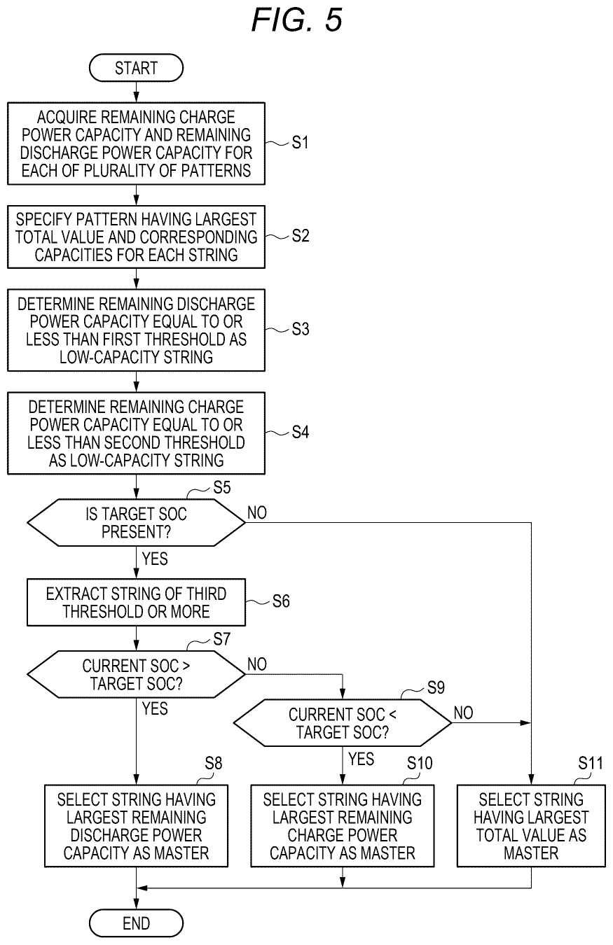

Thereafter, a method for selecting the master string ST of the electricity storage system 1 according to the present embodiment will be described with reference to FIG. 5. FIG. 5 is a flowchart showing a method for selecting the master string ST according to the present embodiment. Processing of FIG. 5 is executed, for example, immediately after the EMS 30 determines the power failure state and the array system 20 starts the second operation mode.

As shown in FIG. 5, first, the acquisition unit 21 of the array system 20 acquires, for the strings ST1 to STm, information on the remaining discharge power capacity and the remaining charge power capacity for each of a plurality of patterns when the bypass circuits BC11 to BCmn switch between the series connection state and the bypass state (S1).

Thereafter, the array system 20 specifies a pattern having the largest total value of the remaining discharge power capacity and the remaining charge power capacity for each of the strings ST1 to STm, and specifies each capacity in the pattern (S2).

Thereafter, the determination unit 22 of the array system 20 determines the string ST having the remaining discharge power capacity in the pattern specified in step S2 equal to or less than the first threshold as the low-capacity string ST (S3). Thereafter, the determination unit 22 determines the string ST having the remaining charge power capacity in the pattern specified in step S2 equal to or less than the second threshold as the low-capacity string ST (S4). Through processing of step S4, the string ST that is not determined as the low-capacity string ST becomes the master candidate.

Thereafter, it is determined whether the information on the target SOC is acquired from the EMS 30 (S5). When the information on the target SOC is acquired (S5: YES), the selection unit 23 of the array system 20 extracts the string ST having the total value in the pattern specified in step S2 equal to or greater than the third threshold (S6).

Thereafter, the array system 20 determines whether the current SOC of the electricity storage system 1 is higher than the target SOC (S7). When the current SOC is higher than the target SOC (S7: YES), the selection unit 23 selects the string ST having the largest remaining discharge power capacity among the strings ST extracted in step S6 as the master string ST (S8). Thereafter, the processing shown in FIG. 5 ends.

On the other hand, when the current SOC is not higher than the target SOC (S7: NO), the selection unit 23 determines whether the current SOC of the electricity storage system 1 is lower than the target SOC (S9). When the current SOC is lower than the target SOC (S9: YES), the selection unit 23 selects the string ST having the largest remaining charge power capacity as the master string ST among the strings ST extracted in step S6 (S10). Thereafter, the processing shown in FIG. 5 ends.

When the information on the target SOC is not acquired (S5: NO) and the current SOC is not lower than the target SOC (S9: NO), the selection unit 23 selects the string ST having the largest total value in the pattern specified in step S2 as the master string ST (S11). Thereafter, the processing shown in FIG. 5 ends.

As described above, according to the electricity storage system 1 in the present embodiment, the array system 20 controls discharging to the load Lo and charging from the solar power generation device 10, and selects the master string ST based on the total value of the remaining discharge power capacity and the remaining charge power capacity excluding the low-capacity string ST having a low remaining discharge power capacity and a low remaining charge power capacity. For this reason, the master string ST is selected in consideration of a range of use (total capacity) useable as a battery from among master candidates having margin for both charging and discharging. Accordingly, the string ST that has certain margin or more during both the charging from the solar power generation device 10 and the discharging to the load Lo and has a certain large total capacity is selected as the master string ST. Therefore, it is possible to provide the electricity storage system 1 that can reduce probability of switching the master string ST and reduce the number of times of switching the master string ST.

Further, when the information on the target SOC is acquired, it is basically easy to execute control such that the target SOC is achieved. Accordingly, when the information on the target SOC is present, the string ST having the largest remaining discharge power capacity or remaining charge power capacity is selected from a relationship with the current SOC. For this reason, the string ST having margin for future control is selected as the master string ST, and the probability of switching the master string ST can be reduced. Therefore, it is possible to provide the electricity storage system 1 that can reduce the number of times of switching of the master string ST.

Here, when the plurality of strings ST1 to STm include the bypass circuits BC11 to BCmn, the bypass circuits BC11 to BCmn cannot be switched when the master string ST is charged and discharged. The bypass circuits BC11 to BCmn are switched through OFF states of both the switches Sa11 to Samn and Sb11 to Sbmn to prevent both the switches Sa11 to Samn and Sb11 to Sbmn from being instantaneously turned on at the same time. For this reason, when both the switches Sa11 to Samn and Sb11 to Sbmn are turned off, power from the master string ST is temporarily stopped and thus the master string ST does not function. Therefore, it is necessary to appropriately perform bypassing in advance to bring out the capability of the master string ST. Therefore, the electricity storage system 1 according to the present embodiment selects the master string ST in a state in which the total value of the remaining discharge power capacity and the remaining charge power capacity is largest among a plurality of patterns when one of the bypass circuits BC11 to BCmn is in the bypass state. Accordingly, the master string ST is selected based on the string ST in a state in which the capability is brought out in advance, and thus it is possible to provide the electricity storage system 1 that can contribute to further reducing the number of times of switching of the master string ST and contribute to reducing the number of times of switching of the master string ST.

Although the present disclosure is described based on the embodiment, the present disclosure is not limited to the embodiment described above, and changes may be made without departing from the gist of the present disclosure, and techniques of embodiments may be combined. Further, publicly known or well-known techniques may be combined if possible.

For example, in the above embodiment, the power failure state in which the grid power cannot be obtained is determined by the EMS 30, but the present disclosure is not limited thereto, and the power failure state may be determined by the array system 20. In addition, each system of the EMS 30, the MOD systems MB11 to MBmn, the ST systems SB1 to SBm, and the array system 20 may be operated by the grid power or may be operated by a power other than the grid power in a non-power-failure state in which the grid power can be obtained. Further, these may include an internal power supply or may receive power from the strings ST of the electricity storage system 1.

In addition, the acquisition unit 21 and the determination unit 22 are mounted on the array system 20, but the present disclosure is not limited thereto, and the acquisition unit 21 and the determination unit 22 may be distributed as certain functions in the ST systems SB1 to SBm. Further, the electricity storage system 1 according to the present embodiment includes the EMS 30, but may not particularly include the EMS 30.

Further, the example shown in FIG. 1 may be applied to a configuration in which power is supplied from each of the strings ST1 to STm to the load Lo via a three-phase circuit of UVW. In this case, the master string ST for the U phase may be selected from the plurality of strings ST1 to STm allocated as the U phase, the master string ST for the V phase may be selected from the plurality of strings ST1 to STm allocated as the V phase, and the W phase may perform the same processing.

In addition, in step S11 shown in FIG. 5, the string ST having the largest total value is selected as the master string ST, but the total value is not particularly limited to the largest and may be randomly selected from the strings ST having the total value equal to or greater than a predetermined threshold. Further, in the above embodiment, the first threshold and the second threshold are assumed to be the same value, but the present disclosure is not particularly limited thereto, and the first threshold and the second threshold may be different values.

Further, the above embodiment described an example in which the master string ST is selected when the operation mode is shifted from the first operation mode to the second operation mode, but the present disclosure is not particularly limited thereto, and may be applied to a case where the master string ST needs to be reselected. The case where it is necessary to reselect the master string ST corresponds to, for example, a case where the discharging proceeds after the master string ST is selected and the array system 20 determines that the remaining discharge power capacity of the master string ST is exhausted. When it is necessary to reselect the master string ST, the array system 20 may determine disconnection in the master string ST. When reselecting the master string ST, the selection unit 23 excludes the string ST selected as the master string ST from the plurality of strings ST1 to STm and reselects the master string ST.

Although various embodiments are described above, it is needless to say that the present disclosure is not limited to these examples. It is apparent that those skilled in the art can come up with various modifications or corrections within the scope of the claims, and it is understood that the modifications or corrections naturally fall within the technical scope of the present disclosure. In addition, components described in the above embodiments may be combined freely without departing from the spirit of the disclosure.

What is claimed is:

1. An electricity storage system that operates in a first operation mode when grid power is supplied to a load and in a second operation mode when the grid power is not supplied to the load, the electricity storage system comprising:
a plurality of electricity storage devices connected in parallel to the load;
a separate system device configured to supply power obtained by natural energy to the load and the plurality of electricity storage devices; and
a control unit configured to control discharging from the plurality of electricity storage devices to the load and charging from the separate system device to the plurality of electricity storage devices, and to perform control to select a master electricity storage device from the plurality of electricity storage devices when an operation mode is shifted from the first operation mode to the second operation mode or when it is necessary to reselect a master electricity storage device, and match voltage, phrase, and frequency between the master electricity storage device and a slave electricity storage device excluding the master electricity storage device among the plurality of electricity storage devices, wherein
the control unit includes:
an acquisition unit configured to acquire information on a remaining discharge power capacity indicating a discharge power capacity until reaching a discharge end voltage and a remaining charge power capacity indicating a charge power capacity until reaching a charge end voltage for each of the plurality of electricity storage devices;
a determination unit configured to determine, among the plurality of electricity storage devices, an electricity storage device whose remaining discharge power capacity acquired by the acquisition unit is equal to or less than a first threshold as a low-capacity electricity storage device, and an electricity storage device whose remaining charge power capacity acquired by the acquisition unit is equal to or less than a second threshold as the low-capacity electricity storage device; and
a selection unit configured to select the master electricity storage device based on a total value of the remaining discharge power capacity and the remaining charge power capacity acquired by the acquisition unit of each electricity storage device that is a master candidate excluding the low-capacity electricity storage device determined by the determination unit from the plurality of electricity storage devices.

2. The electricity storage system according to claim 1, wherein
when information on a target state of charge that is a target is acquired for the plurality of electricity storage devices, for an electricity storage device having the total value equal to or larger than a third threshold among electricity storage devices that are master candidates, the selection unit selects an electricity storage device having the largest remaining discharge power capacity when a current state of charge exceeds the target state of charge, and selects an electricity storage device having the largest remaining charge power capacity when the current state of charge is less than the target state of charge.

3. The electricity storage system according to claim 1, wherein
each of the plurality of electricity storage devices includes a plurality of storage batteries connected in series and a plurality of bypass circuits configured to bypass the respective storage batteries by disconnecting the storage batteries from a series connection state,
the acquisition unit acquires, for each of the plurality of electricity storage devices, information on the remaining discharge power capacity and the remaining charge power capacity for a plurality of patterns when one of the plurality of bypass circuits is bypassed, and
the selection unit selects, for each of the plurality of electricity storage devices, the master electricity storage device in a bypass state having the largest total value of the remaining discharge power capacity and the remaining charge power capacity among the plurality of patterns.
